(19) United States
(12) Patent Application Publication
(10) Pub. No.: US 2010/0253847 A1
(43) Pub. Date: Oct. 7, 2010

(54) TWO-STAGE DIGITAL PROGRAM INSERTION SYSTEM

(75) Inventors: Edward A. Krause, Saratoga, CA (US); Peter Monta, Palo Alto, CA (US); Ramin Farassat, San Jose, CA (US); Adam Tom, San Francisco, CA (US)

Correspondence Address: Lipsitz & McAllister, LLC, 755 MAIN STREET, MONROE, CT, 06468, US

(73) Assignee: RGB Networks, Inc., Sunnyvale, CA (US)

(21) Appl. No.: 12/384,278

(22) Filed: Apr. 1, 2009

(51) Int. Cl. H04N 9/74; H04N 7/167

(52) U.S. Cl. 348/584; 380/210

(57) ABSTRACT

Apparatus and methods are provided for inserting advertisements and/or to perform grooming functions after a video, audio and/or data stream has been transrated and/or encrypted. In this manner, ad insertion and grooming can be performed close to the edge of a video distribution network. Transrating and encryption of a program into which content is to be later inserted can be accomplished before the program is transmitted. Thus, a single encrypted version of a program can be transmitted from a central point in the network to multiple recipients, while providing the benefits of subsequent targeted ad insertion or grooming downstream of the central point.

### BACKGROUND OF THE INVENTION

The present invention relates to digital video communication, and more particularly to the insertion of advertisements and the like into a multiplex of digital video streams. The invention also relates to the grooming of digital video streams, such as for recombining selected programs from one or more sources.

The process of inserting advertisements into video programming became much more complex after the transition from analog video to compressed digital formats such as MPEG1 and MPEG2. Instead of substituting analog waveforms (or digitized pixels) from one signal to another, it became necessary to first identify a suitable exit point in a first compressed digital stream, and then to align this exit point with a suitable entrance point into a second compressed digital stream. In addition, many parameters needed to be added, modified, or replaced, in order to maintain seamless continuity during the splicing transition. In fact, most digital splicing products in existence today not only modify these parameters, but also regenerate the entire stream. This is done to insure that the data rate of the resulting stream remains within the limits of the communication channel used to convey the signal from the splicer to one or more receiving devices. This data rate modification process is often referred to as transrating.

The combination of splicing and transrating capabilities is particularly advantageous in products designed for ad insertion as well as products designed for grooming. Grooming refers to the recombination of selected programs from one or more sources. It is an application which typically depends on transrating to match the combined rate of the selected programs with the data rate of the communications channel. In this case, if changes are made to the selection of programs, or if advertisements are inserted into one or more of these selected programs, then the transrating process will automatically insure that the capacity of the communication channel is never exceeded.

In many applications, video and audio streams are encrypted prior to distribution in order to prevent unauthorized access to the content. Ad-insertion and grooming operations are usually performed before encrypting, since both processes generally require access to certain headers while they remain in the clear. For example, certain header fields must be modified if an ad insertion splice is to be seamless, and many transraters are designed to perform a full recompression process and therefore require unrestricted access to the entire video stream.

In some cases, it would be advantageous to insert ads or perform grooming and transrating functions after a stream has been encrypted. For example, if the same stream is to be broadcast to multiple recipients, then it may be more effective to insert multiple customized ads in order to better address the needs of each individual recipient or group of recipients. This matching of ads with attributes of known recipients is known as targeted advertising.

Unfortunately, it may not be desirable or even possible to defer the encryption process until each of the customized ads has been inserted. For example, the ads may be inserted at various downstream locations, and it may be necessary to protect the content before it is transmitted to these downstream locations. Additional considerations are the cost of encryption, and the availability of bandwidth. Each time a customized ad is inserted into the stream, a new version of the stream is created. Therefore, the cost of encrypting multiple versions must be considered. Furthermore, if the multiple versions are created upstream by co-locating the ad servers with the encrypter, then additional bandwidth will be needed to accommodate each of the customized versions as they are transmitted to their intended viewers.

For these and other reasons, it is often desirable to perform ad insertion and/or grooming close to the edge of a video distribution network and to encrypt content before it is transmitted from a more central point in the same network. This would require the ad insertion and grooming to be applied to already encrypted video streams.

Accordingly, it would be advantageous to provide a solution to the problem of transmitting a single encrypted version of a program from a central point in the network to multiple recipients, while still realizing the benefits of targeted ad insertion and/or grooming. The present invention provides a solution with these and other benefits.

### SUMMARY OF THE INVENTION

A method is provided for inserting content into a video stream. The video stream is received, and a cueing message is extracted therefrom. The cueing message is indicative of a splice point within the video stream. The video stream is conditioned in response to the cueing message to indicate the location of the splice point in a manner adapted to survive the subsequent transrating of the video stream. The conditioned video stream is transrated, and conveyed to a splicer. The content to be inserted is also conveyed to the splicer for insertion into the transrated conditioned video stream at the splice point.

The conditioning step can condition the video stream in response to the cueing message to indicate the location of the splice point in a manner adapted to survive both the subsequent transrating and the subsequent encryption of the video stream.

The video stream can be received at a pre-splicer which performs the extracting and conditioning steps. The pre-splicer can receive and convey the content to the splicer via one of an inband or out-of-band channel. The content can be conveyed to the splicer without being transrated. The content can also be conveyed to the splicer without being encrypted.

The conditioned video stream can be encrypted after the conditioning step and before the content is inserted therein. Alternatively, the conditioned video stream can be encrypted after the conditioning and transrating steps, and before the content is inserted therein. The content can be conveyed to the splicer without being transrated. The content can also be conveyed to the splicer without being encrypted.

Apparatus is provided for inserting content into a video stream. The apparatus includes a pre-splicer adapted to (i) receive the video stream; (ii) extract information indicative of a splice point from the video stream; and (iii) condition the video stream to indicate the location of the splice point in a manner adapted to survive the subsequent transrating of the video stream.

A transrater is coupled to receive and transrate the conditioned video stream from the pre-splicer. A splicer is coupled to receive the transrated video stream from the transrater and to receive content to be inserted into the transrated video stream from a content server. The splicer inserts the received content into the transrated video stream at the splice point.

The apparatus can further comprise an encrypter between the transrater and the splicer.

In one embodiment, the pre-splicer receives the content from the content server and conveys the received content to the splicer via one of an inband or out-of-band channel independent of the transrater.

In another embodiment, the splicer receives the content directly from the content server.

The pre-splicer can condition the video stream to indicate the location of the splice point by providing splice identifier information in an unencrypted adaptation header carried in a transport packet of the video stream. The pre-splicer can further provide insertion interval duration information in the unencrypted adaptation header. The pre-splicer can also provide (e.g., in the unencrypted adaptation header) attributes of the content which must be satisfied for compatibility with the insertion interval defined by the insertion interval duration information. The attributes of the content can include, for example, a maximum data rate of the content.

Where a maximum data rate of the content is provided, the transrater can examine this parameter and carve out room for the content before the content is inserted at the splicer.

The pre-splicer can insert the splice identifier information in adaptation headers at intervals which are prior to but do not immediately precede the splice points. This will subsequently allow sufficient time for communication and synchronization with the content server prior to inserting the content into the video stream.

### BRIEF DESCRIPTION OF THE DRAWINGS

FIG. 1 is a block diagram of a prior art advertisement insertion system for use in digital video program distribution;

FIG. 2 is a block diagram of a first embodiment of a digital program (e.g., ad) insertion system in accordance with the present invention;

FIG. 3 is a block diagram of a second embodiment of a digital program (e.g., ad) insertion system in accordance with the present invention;

FIG. 4 is a diagram illustrating various MPEG transport stream fields and the use of such fields in accordance with the present invention;

FIG. 5 is a block diagram showing the use of the present invention in a large distribution system;

FIG. 6 is a data rate diagram showing the combined data rates of various variable rate streams that can be processed in accordance with the invention;

FIG. 7 is a data rate diagram showing combined data rates for the streams indicated in FIG. 6 after inserting new segments in accordance with the invention;

FIG. 8 is a data rate diagram showing combined data rates for the streams indicated in FIG. 7 after transrating, wherein the combined data rate of a multiplex of six streams remains less than or equal to the channel capacity C.

### DETAILED DESCRIPTION OF THE INVENTION

Although the invention is described with multiple references to the process of ad insertion, it should be realized that the solution is equally applicable to grooming applications where splicing occurs between video streams consisting of arbitrary unrelated video content of limited or unlimited durations.

A block diagram of a prior-art ad insertion system is shown in FIG. 1. In such prior art systems, insertion opportunities are typically signaled by cueing messages present in the input stream 14 provided to the splicer 10. Once the splicer commits to an upcoming splice, it communicates with the ad server 12 via a-network 20. The ad server 12 then sends the next ad via path 16 to the splicer 10 just prior to the time of insertion. The splicer 10 inserts the ad at the precise point signaled by the cueing messages and performs all steps necessary to implement a seamless transition. The output 18 of the splicer 10 can then be sent to a prior-art transrater module, followed by a prior-art encryption module. An example of such a prior art ad insertion system can be found in U.S. Pat. No. 5,917,830 entitled “Splicing Compressed Packetized Digital Video Streams.”

For cable systems, the widely adopted standard specifying the format of the cueing messages in MPEG-2 transport streams is referred to as SCTE 35, entitled “Digital Program Insertion Cueing Message for Cable”, a copy of which is available at http://www.scte.org/documents/pdf/ANSISCTE352004.pdf. Similarly, the adopted standard specifying the communication protocol between the splicer and the ad server is SCTE 30, entitled “Digital Program Insertion Splicing API”, available at http ://www.scte.org/documents/standards/approved/ANSISCTE302006.pdf. Both of these standards have been extended for compatibility with newer video compression standards. An example of such a video compression standard is the well known H.264 standard, which is equivalent to MPEG-4 Part 10, or MPEG-4 AVC (for Advanced Video Coding).

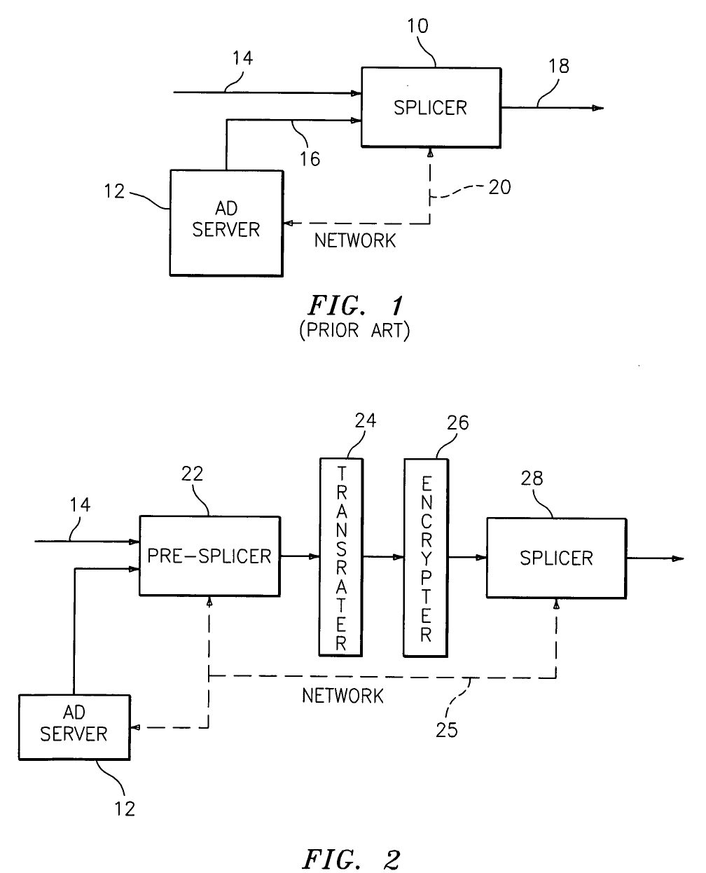

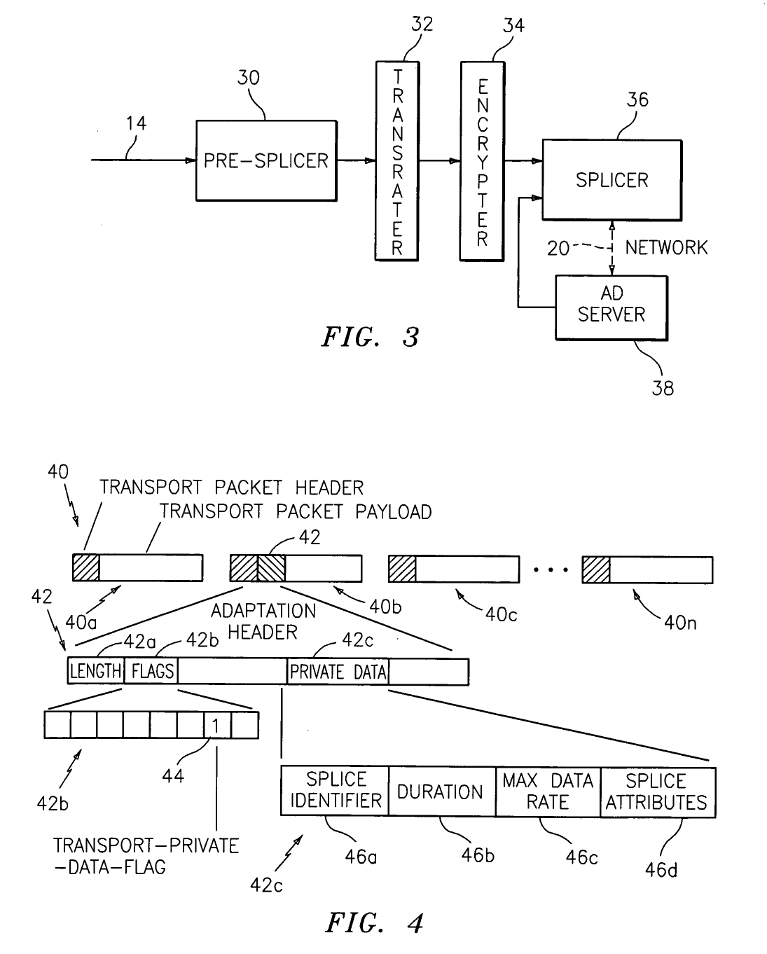

FIG. 2 illustrates one embodiment of an ad insertion system in accordance with the present invention. Instead of having the splicer receive cueing messages and communicate with the ad server as in the prior art embodiment of FIG. 1, the embodiment of FIG. 2 includes a pre-splicer module 22 for receiving the cueing messages in the input stream 14 and communicating with the ad server 12. However, the ad is not spliced into the network stream, even though it is received from the ad server at the scheduled time. Instead, the pre-splicer assumes the role of the ad server and conveys the ad to the splicer using any available inband or out-of-band channel. For example, the pre-splicer 22 may transmit an ad to the splicer over an Ethernet network (e.g., network 25), while communicating with the splicer 28 using the protocols specified by SCTE-30. The pre-splicer 22 could optionally be designed to request the ad from the server 12 well in advance of the scheduled splice time, in order to allow additional time for processing either at the pre-splicer 22 or splicer 28.

The pre-splicer also performs another important task. It conditions the output data stream in such a way that the precise location of splicing points, as well as all parameters needed to implement a seamless splice, will survive the subsequent transrating and encryption processes.

A transrater 24 and encrypter 26 are also shown in FIG. 2. In accordance with the present invention, these functions are now implemented in front of the splicer 28, which can now be relocated downstream, closer to the edge of the network. Communications between the ad server 12, pre-splicer 22 and splicer 28 can be conducted via a network 25. The transrater 24 performs data rate modification as well known in the art, and the encrypter 26 encrypts the data provided to the splicer 28 as necessary.

Note that the ads which are stored on the ad server 12 may be either encrypted or in the clear. In most applications, there is little interest in protecting the ad content from unauthorized access. However, if it is desirable to encrypt multiple ads in real time using the same encrypter as used for the network stream, then this may be accomplished using a multiplexed encryption design as described in US patent publication 2005-0180568 entitled “Time-Multiplexed Multi-Program Encryption System” and incorporated herein by reference. In this approach, the most important segments of multiple ads are selected and combined for transmission during the ad insertion interval of a particular network stream.

An alternate embodiment of the invention is shown in FIG. 3. As in the prior-art system of FIG. 1, the ad server 38 interfaces directly to the splicer 36, and therefore the pre-splicer 30 only needs to condition the input stream 14 by marking the location of splicing points and extracting certain parameters from the input stream so that they remain visible to the splicer once the stream is encrypted. As before, the splicer 36 is capable of extracting this repackaged information, but is otherwise conventional in design. As an example, the pre-splicer 30 could identify splicing points by examining SCTE-35 cue messages and then conveying this information to the splicer 36 using a modified format. The splicer 36 would receive this information and then communicate with the ad server 38 using the SCTE-30 protocols. The ads received from the ad server 38 would then be inserted in place of the network television content contained in input stream 14. Once the last ad has been streamed, the splicer would initiate a seamless splice back to the network stream, and wait for the next insertion interval before the process is repeated.

A preferred method for conveying information from the pre-splicer 22 (FIG. 2) or 30 (FIG. 3) to the respective splicer 28, 36 is illustrated in FIG. 4. In this example, the information provided by the pre-splicer is encapsulated into MPEG2 adaptation headers 42 of an MPEG2 transport stream 40. In particular, with reference to FIG. 4, some MPEG2 transport packets (such as packet 40b shown) can contain an adaptation header 42. This method is compatible with the widely-adopted ISO/IEC 13818-1 standard used for distributing video and audio in cable, Telco, and satellite networks. In general, adaptation headers are not encrypted at anytime during the distribution process.

In the example implementation of FIG. 4, the private data field 42c of the adaptation header 42 is used for conveying information from the pre-splicer to the splicer.

Therefore, an adaptation header is created (if one does not already exist) immediately prior to the desired splice point in a particular video, audio or data stream. The adaptation header 42 includes a length field 42a, flags 42b, and a private data field 42c. Within the flags 42b is a transport_private_data_flag 44, which is set to ‘1’. The relevant information is then inserted into the private data field 42c, as specified by the ISO/IEC 13818-1 specification (available at www.iso.org).

As shown in FIG. 4, the information carried by the private data field 42c can include a splice identifier 46a to confirm the presence of a splice point immediately following the adaptation header. A duration tag 46b can be provided to specify the duration of the insertion interval. The maximum data rate of the ad should be specified if it is known. Since the inserted ads will be replacing the default ad, the maximum data rate may be set to match the rate of the existing default. The maximum data rate can be indicated as a separate tag 46c in the private data field 42c. Additional splice attributes 46d can be provided to identify attributes of the ads which must be satisfied for compatibility with the insertion interval.

Note that in many systems, timing information such as presentation and decoding time stamps are subsequently encrypted, and therefore will not be available to the splicer. For this reason, the pre-splicer must examine the SCTE-35 cue messages, as well as the time stamps present in the video, audio, and data streams, in order to determine the precise location of a splicing exit or entrance point. Although the location of splicing points may be precisely conveyed from the pre-splicer to the splicer by inserting adaptation headers immediately before the splice entrance and exit points, it may also be important to allow time for communication and synchronization with the ad server. Therefore, it may be advantageous to insert the adaptation headers at intervals preceding the splice points. Additional information can be inserted into the header to specify either the time interval before the splice is to be executed, or if the splice is to be executed immediately.

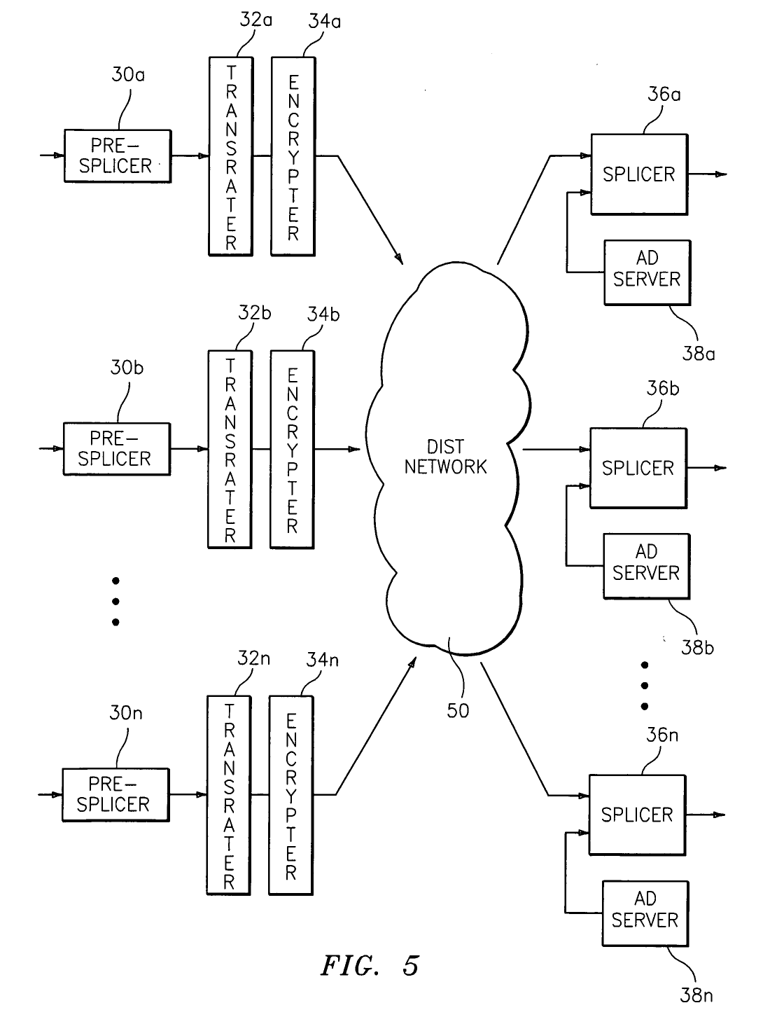

The ad processing system of FIG. 3 can be expanded and applied to a large distribution system 50 as shown in FIG. 5. In this example, the stream capacity of the pre-splicers 30a, 30b . . . 30n is-assumed to be matched with the capacity of the associated transraters 32a, 32b . . . 32n and encrypters 34a, 34b . . . 34n. Similarly, the stream capacity of the splicers 36a, 36b . . . 36n is assumed to be matched with the stream capacity of the associated ad servers 38a, 38b . . . 38n. In practice this may not be the case and accordingly, this representation is provided merely as an example. It should be understood that each component of the distribution system could be provided as a scalable subsystem, with either central or dedicated access offered to other networked components. In this case, it is assumed that each module is capable of simultaneously supporting a large number of streams. This is particularly common with certain components such as the transrater in a cable delivery system where multiple programs are often statistically multiplexed into signals which must not exceed the fixed capacity of the various communication channels. Although each component stream of a particular multiplex may be variable in rate, the transrater must ensure that the combined rate of the component streams remains less than or equal to the channel capacity.

In a typical system, the transrater would be placed after the ad insertion splicer and before the encrypter. In this way, the transrater is able to process the video signals while they remain in the clear, and is able to even out the data rate fluctuations introduced by the insertion of new video content. However, the example implementations disclosed herein place the transrater in front of the ad servers and the ad splicers. Therefore, the transrater should be modified in order to carve out room for the ad before the ad is inserted at the splicer. This can be done by examining the max data rate tag 46c that was described previously with reference to FIG. 4. For example, if it is determined that the ad interval should support all ads encoded at a data rate of 3.75 mb/s or less, then the max data rate tag could be specified as 3.75 mb/s. This tag could be inserted by the pre-splicer, or the decision could be deferred and applied at the transrater itself.

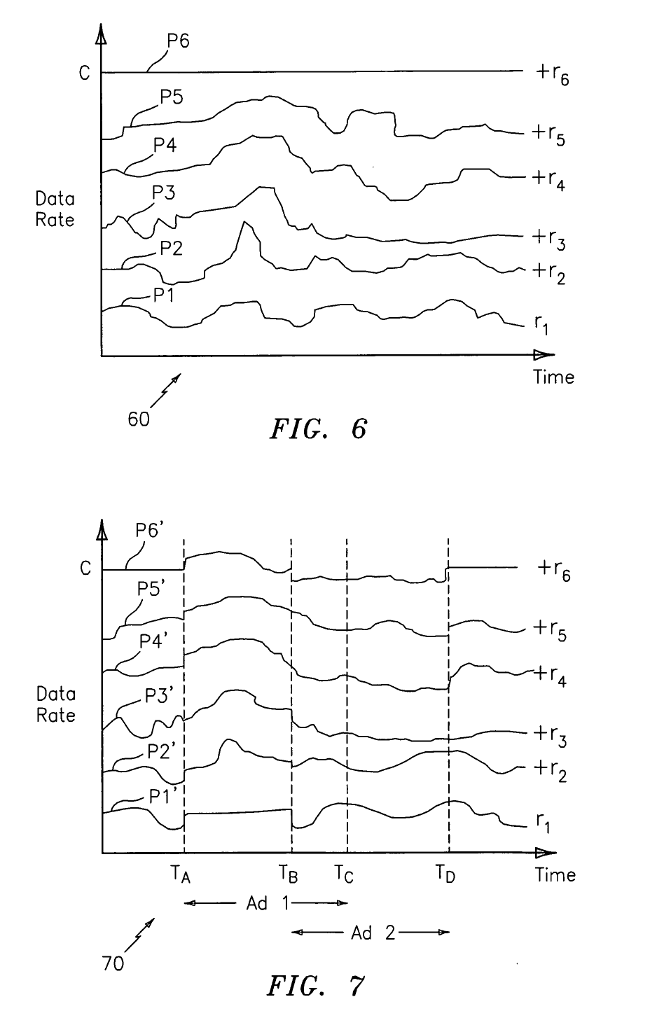

The amount of transrating that is needed depends on the max data rate tag, as well as the rate of each component stream, including the stream(s) that is being replaced. Consider the example in FIG. 6 which comprises a data rate diagram 60 showing a multiplex comprised of six variable rate video streams. The line P1 shows the data rate r1 of a first video stream (“stream 1”). P2 represents the combined data rate (r1+r2) of stream 1 and a second video stream (“stream 2”). P3 shows the combined data rate (r1+r2+r3) of stream 1, stream 2 and a third video stream (“stream 3”). P4 represents the combined data rate (r1+r2+r3+r4) of stream 1, stream 2, stream 3 and a forth video stream (“stream 4”). P5 shows the combined data rate (r1+r2+r3+r4+r5) of stream 1, stream 2, stream 3, stream 4 and a fifth video stream (“stream 5”). P6 represents the combined data rate (r1+r2+r3+r4+r5+r6) of stream 1, stream 2, stream 3, stream 4, stream 5 and a sixth video stream (“stream 6”). Although the data rate of each individual program varies, the combined rate of all six video streams remains constant, as illustrated by P6. This is typical of applications where multiple programs are encoded simultaneously using a statistical multiplexer to manage the data rate. By allocating more bits to the programs which are difficult to compress and fewer bits to the programs which are more easily compressed, the statistical multiplexer is able to deliver higher quality video on a more consistent basis.

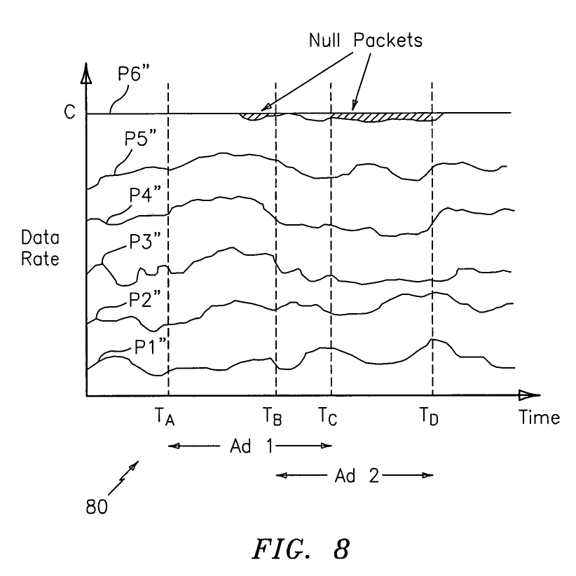

Assume that a segment of the first stream (video stream 1) and a segment of the forth video stream (video stream 4) are to be replaced by advertisements. The result after inserting these new segments is shown in the data rate diagram 70 of FIG. 7. At times, the data rate of the inserted ads may be lower than the segments they replace, while at other times, the data rate of the inserted ads may be higher. The result is that the multiplex may periodically exceed the data rate available for transmission, as shown at P6′. This problem may be fixed by transrating.

Typically, the transrater operates as a statistical remultiplexer and attempts to deliver consistent video quality across all programs. As the combined data rate begins to exceed the data rate capacity of the transmission channel, the transrater increases the recompression ratio, resulting in a slight degradation in video quality on all programs. This is generally considered to be a better result than a larger degradation to the quality of one or more channels, while there is little or no degradation to others.

A conventional statistical remultiplexing transrater can be modified to allow for substitution of programming content at subsequent downstream locations. A simple solution is to modify the channel capacity parameter that is supplied to the transrater.

For example, immediately after the new content is spliced into video stream 1 at time instant TA shown in FIG. 7, the channel capacity parameter should be changed from the original value C to the modified value of C−R1+r1, where R1 is the maximum data rate of the ad (specified by the max data rate tag 46c referred to in FIG. 4) and r1 is the instantaneous rate of the program 1 segment that is to be replaced. An easy way to achieve the same result without the ambiguity of computing instantaneous data rates is to model the fullness of a common buffer used to implement the multiplexer. In this case, data is collected in this buffer as it arrives from each of the six stream sources. At the same time, data is removed from the buffer at a constant rate C. Therefore, each time the buffer is examined, the buffer level is increased by counting the number of packets that have arrived from each source, and the buffer level is decreased by counting the number of packets that have been transmitted. The number of transmitted packets can be calculated based on the channel data rate C and the time interval since the buffer was last examined. In this way, the fullness of the buffer can be determined at any time. Note that if the buffer becomes empty, then a null packet must be transmitted and included in the net result.

Once the first splice is implemented for program 1 at time TA, the buffer fullness calculation is modified. Packets continue to be subtracted from the buffer at a constant rate C, while packets arriving from streams 2 to 6 continue to be added to the buffer. Although the new content for program 1 is not yet available for inclusion in the multiplex, the transrater rate control system can account for its presence by assuming a constant packet arrival rate R1. These hypothetical new packets to replace program 1 are added to the buffer fullness calculation. At the same time, the original packets corresponding to program 1 are subtracted from the buffer fullness result as they are processed. This new buffer fullness result is then used in place of the original fullness result when determining whether to increase or decrease the amount of video recompression. An example of a preferred method for mapping the multiplexer buffer fullness level to a video quality setting applicable to transrater systems is described in US patent publication 2008-0068997 entitled “Methods and Apparatus for Rate Estimation and Predictive Rate Control”, incorporated herein by reference.

In the example of FIG. 7, a second ad is spliced into video stream 4 beginning at time TB, causing two ads to be injected into the multiplex during the interval from TB to TC. The transrater can insure that there is sufficient room in the multiplex for both ads by assuming a channel capacity of C−R1+r1−R4+r4, where R4 is the maximum data rate of the second ad (specified by the max data rate tag 46c referred to in FIG. 4), and r4 is the instantaneous rate of the program 4 segment to be replaced. As before, a practical implementation is to adjust the multiplexer buffer fullness upwards as the arrival of new video stream 1 and video stream 4 packets are modeled at constant rates R1 and R4 respectively, and to adjust the multiplexer buffer fullness downwards as existing video stream 1 and video stream 4 packets are encountered in the original multiplex.

At time instant TC, the transrater adjusts the rate control calculation to account for the splice from ad stream 1 back to the original video stream 1. The channel capacity is now adjusted to become C−R4+r4. Finally, after completion of the ad for video stream 4 at time TD, the channel capacity reverts back to the nominal setting C, and normal transrater operation resumes until the next insertion interval. The result after transrating is illustrated in the data rate diagram 80 of FIG. 8. Note that the total combined data rate shown at P6″ now remains less than or equal to the channel capacity C. If the combined rate is less than C, then null packets are inserted.

Depending on encoder settings used during compression of the ad segments, it may be necessary to consider transient data rates at each of the splicing points. This potential problem can be dealt with either by strictly enforcing the rate constraint at the beginning and end of each insertable ad, or by assuming worst case transition events during the transrating process. This is discussed in commonly owned co-pending U.S. provisional patent application No. 61/133,614 filed on Jun. 30, 2008 and entitled “Preconditioning Ad Content for Digital Program Insertion”, incorporated herein by reference.

It should now be appreciated that the present invention provides apparatus and methods for inserting advertisements and/or to perform grooming functions after a video, audio and/or data stream has been transrated and/or encrypted. In this manner, ad insertion and grooming can be performed close to the edge of a video distribution network. Transrating and encryption of a program into which content is to be later inserted can be accomplished before the program is transmitted. Thus, a single encrypted version of a program can be transmitted from a central point in the network to multiple recipients, while providing the benefits of subsequent targeted ad insertion or grooming downstream of the central point.

What is claimed is:

1. A method for inserting content into a video stream, comprising:
receiving said video stream;
extracting a cueing message from the received video stream, said cueing message being indicative of a splice point within said video stream;
conditioning said video stream in response to said cueing message to indicate the location of said splice point in a manner adapted to survive the subsequent transrating of said video stream;
transrating the conditioned video stream;
conveying the transrated video stream to a splicer; and
conveying said content to said splicer for insertion into the transrated conditioned video stream at said splice point.

2. The method of claim 1 wherein said conditioning step conditions said video stream in response to said cueing message to indicate the location of said splice point in a manner adapted to survive both the subsequent transrating and the subsequent encryption of said video stream.

3. The method of claim 1 wherein said video stream is received at a pre-splicer, and said pre-splicer performs said extracting and conditioning steps.

4. The method of claim 3 wherein said pre-splicer receives and conveys said content to said splicer via one of an inband or out-of-band channel.

5. The method of claim 4 wherein said content is conveyed to said splicer without being transrated.

6. The method of claim 5 wherein said content is conveyed to said splicer without being encrypted.

7. The method of claim 1 wherein the conditioned video stream is encrypted after said conditioning step and before the content is inserted therein.

8. The method of claim 1 wherein the conditioned video stream is encrypted after said conditioning and transrating steps, and before the content is inserted therein.

9. The method of claim 1 wherein said content is conveyed to said splicer without being transrated.

10. The method of claim 9 wherein said content is conveyed to said splicer without being encrypted.

11. Apparatus for inserting content into a video stream, comprising:
a pre-splicer adapted to:
(i) receive the video stream;
(ii) extract information indicative of a splice point from said video stream; and
(iii) condition said video stream to indicate the location of said splice point in a manner adapted to survive the subsequent transrating of the video stream;
a transrater coupled to receive and transrate the conditioned video stream from said pre-splicer;
a splicer coupled to receive the transrated video stream from said transrater and to receive content to be inserted into the transrated video stream from a content server;
wherein said splicer inserts the received content into the transrated video stream at said splice point.

12. Apparatus in accordance with claim 11 further comprising an encrypter between said transrater and said splicer.

13. Apparatus in accordance with claim 11 wherein said pre-splicer receives said content from said content server and conveys the received content to said splicer via one of an inband or out-of-band channel independent of said transrater.

14. Apparatus in accordance with claim 11 wherein said splicer receives said content directly from said content server.

15. Apparatus in accordance with claim 11 wherein said pre-splicer conditions said video stream to indicate the location of said splice point by providing splice identifier information in an unencrypted adaptation header carried in a transport packet of said video stream.

16. Apparatus in accordance with claim 15 wherein said pre-splicer further provides insertion interval duration information in said unencrypted adaptation header.

17. Apparatus in accordance with claim 16 wherein said pre-splicer further provides, in said unencrypted adaptation header, attributes of said content which must be satisfied for compatibility with the insertion interval defined by said insertion interval duration information.

18. Apparatus in accordance with claim 17 wherein said attributes of said content include a maximum data rate of the content.

19. Apparatus in accordance with claim 16 wherein said transrater examines said maximum data rate and carves out room for said content before the content is inserted at said splicer.

20. Apparatus in accordance with claim 15 wherein said pre-splicer inserts said splice identifier information in adaptation headers at intervals which are prior to but do not immediately precede the splice points.
